(19) United States
(12) Patent Application Publication
(10) Pub. No.: US 2017/0297840 A1
(43) Pub. Date: Oct. 19, 2017

(54) TRANSPORT UNIT WITH NEGATIVE PRESSURE DEVICE AND METHOD FOR TRANSPORTING TRAYS

(71) Applicant: MULTIVAC Sepp Haggenmüller SE & Co. KG, Wolfertschwenden (DE)

(72) Inventors: Luciano Capriotti, Bad Gronenbach (DE); Lars Mörschner, Lauben (DE)

(21) Appl. No.: 15/488,344

(22) Filed: Apr. 14, 2017

(30) Foreign Application Priority Data
Apr. 19, 2016 (EP) 16 166 040.2

(51) Int. Cl. B65H 3/12; B65G 59/10; B65H 3/10; B65G 59/06

(52) U.S. Cl. CPC B65H 3/126; B65G 59/10; B65H 3/122; B65G 59/06; B65H 3/10; B65H 3/124; B65H 3/12

(57) ABSTRACT

A transport unit that comprises a de-stacking device which is configured to drop trays from a stack of trays individually or in groups into a drop area, and a transport belt unit with a transport surface passing through the drop area for receiving and transporting away the dropped trays. The transport surface may comprise at least one opening. A negative pressure device may be provided to generate a suction force in the drop area through one or more of the openings of the transport surface, wherein the suction force sucks the dropped trays in the drop area in a direction towards the transport surface. This configuration reduces the rebound of the trays when they impact the transport surface as they are dropped. The invention also relates to a corresponding method for transporting trays.

### CROSS-REFERENCE TO RELATED APPLICATIONS

This Application claims priority to European Patent Application Number 16166040.2 filed Apr. 19, 2016, to Luciano Capriotti and Lars Mörschner, currently pending, the entire disclosure of which is incorporated herein by reference.

### FIELD OF THE INVENTION

The present invention relates to a transport unit with which trays can be transported away from a stack of trays individually or in groups, and a corresponding method for transporting trays.

### BACKGROUND OF THE INVENTION

Stackable packages are used for packaging a variety of consumer goods, in particular foodstuffs. Examples of this are the plastic trays that are customary in the sector of meat products and can be sealed with a film after being filled. The packages are frequently stored and dispatched in a stacked manner in order to save space. For being filled with products, however, the packages must then be supplied individually or in groups to a filling station.

For example, it is known from practice to drop—by use of a de-stacking device receiving a stack of plastic trays—at specific time intervals the respective lowermost tray of the stack onto a transport belt running beneath the de-stacking device. The trays thus separated from the stack are then transported to a filling station with the transport belt where they are filled with the desired products, in particular foodstuffs. The filled trays are then taken to a sealing station where they are sealed with plastic film.

A de-stacking device with which the lowermost tray is at fixed temporal intervals dropped from a stack of trays onto a transport belt guided beneath the de-stacking device is known from EP 1 685 047 B1.

A current disadvantage when dropping trays, in particular package trays, from a stack onto a transport belt passing beneath the stack is that trays rebound from the transport belt after impacting the transport belt. Further, since there is not the necessary friction between the tray and the transport belt during the rebound, the tray is not immediately subjected to the transport speed of the transport belt. This results in irregular slippage of the transport belt beneath the trays during the impact and during the rebound, and ultimately to irregular spacing between successively dropped trays in the transport direction. In addition even with a slight rebound, the orientation of the tray on the transport belt is unpredictable, which is disadvantageous in subsequent processing steps.

### SUMMARY OF THE INVENTION

It is therefore an object of the invention to provide a transport unit as well as a method for transporting trays with which the dropping of trays from a stack of trays onto a transport surface is improved with regard to the positional accuracy of the trays.

Although the background of the invention has been described with respect to de-stacking and transporting away packages, a preferred application of the invention is also in this field; however, the invention is not restricted to this application, but is intended to be generally applicable to de-stacking and transporting away individual or groups of trays from a stack of trays.

A transport unit according to the invention comprises a de-stacking device which is configured to drop trays from a stack of trays to a drop area. The trays can be dropped individually or in groups. The dropping of the trays from the stack can be effected by active acceleration for a motion into the drop area. However, this is not necessary. Alternatively, a holding force applied to the tray can be suspended when a tray is dropped and the tray can then be released into the drop area. Also mechanisms that combine actively dropping and releasing trays are possible. The transport unit according to the invention comprises a transport belt unit with a transport surface passing through the drop area for receiving and transporting away the dropped trays. Advantageously, the transport surface passes through the drop area beneath the de-stacking device, so that the trays have only to be released onto the transport surface by the de-stacking device.

According to the invention, the transport surface comprises at least one opening. The transport unit may comprise a negative pressure device that is configured to generate a suction effect in the drop area through one or more of the openings of the transport surface. The negative pressure device applies a suction force to the dropped trays in the drop area in a direction towards the transport surface.

The suction due to the negative pressure device of the present invention may also remove an air cushion present between the tray and the transport surface during the dropping of the tray. This helps to prevent the tray from rebounding from the transport surface or at least reduces the magnitude of the rebound. The positioning accuracy of the trays on the transport surface can also be improved by applying the suction force, in particular with respect to the orientation of the trays. A further positive effect of the suction force is that the trays are directly pressed onto the transport surface after impacting the transport surface in the drop area. As a result, the necessary friction between a tray and the transport surface to effect the transport of the trays on the transport surface can be obtained very quickly. The suction force also improves the positioning accuracy of the trays on the transport surface, in particular with respect to the spacing between successive trays. In addition, more rapid movement or depositing of the trays onto the transport surface is enabled, which may result in a higher cycle output.

The transport belt unit of the transport unit according to the invention can be implemented in various ways.

According to a simple embodiment, the transport belt unit may comprise a transport belt that passes through the drop area and compress the transport surface. A plurality of openings of any shape may be provided in the transport belt, through which the suction force is applied. Advantageously, openings may be provided regularly along the entire length of the transport belt at certain distances from each other, so that one or more openings are always present in the drop area while the transport belt is running. However, it would also be conceivable for the transport belt to have openings in only certain regions along its length in the direction of transport. If necessary, the circulating speed of the transport belt could be coordinated with the drop cycle of the de-stacking device in order to ensure that one or more openings of the transport surface are always present in the drop area when a tray impacts the transport surface, so that the tray can in the drop area be sucked in the direction towards the transport surface.

According to another embodiment, the transport belt unit may comprise a link belt that, at least in part or entirely, forms the transport surface. In this case, the spacing between the links of the link belt can form the openings of the transport surface allowing the application of the suction force. Embodiments with a link belt can be easily realized since link belts of various types have already been known for a long time (see as an example, WO 99/65801 A1) and are commercially available.

According to a further embodiment, the transport belt unit may comprise several transport belts being mutually spaced and running in parallel which together at least in part or entirely form the transport surface. An intermediate space between adjacent transport belts can form an opening of the transport surface by way of which the suction effect is generated. The transport belt unit for this purpose may comprise two mutually spaced transport belts running in parallel. Dropped trays can then rest on one or both transport belts and on either side of the intermediate space between the transport belts. The suction force on the trays can be applied by the negative pressure device through the intermediate space existing between the transport belts. Depending on the type of tray to be transported, however, it can also be advantageous to provide a larger number of transport belts being mutually spaced from each other and running in parallel, for example, more than 2, more than 5, or more than 10 transport belts. With a larger number of transport belts, the stability of the trays bearing on the transport surface may be improved.

The negative pressure device can comprise a negative pressure generator and a suction attachment connected thereto with a suction opening through which air can be drawn in. The suction attachment can be positioned in the drop area on the side of the transport surface which is opposite to that of the dropped trays. The location and the spatial extent of the suction effect can be defined with the suction attachment. Depending on the size and/or weight of the dropped trays, a suitable suction attachment can be selected in order to prevent the trays from rebounding off the transport surface.

The rebound behavior of the trays can be improved particularly efficiently if a cross-section of the suction opening covers the area corresponding to at least a base surface of the tray that engages or bears on the transport surface after being dropped.

The invention is preferably applied to de-stacking and transporting away plastic trays, cardboard trays, aluminum trays, glass trays or trays made of foamed material, in particular Styrofoam. With such trays, as are used in particular in the packaging industry in particular for packaging foodstuffs, a particularly pronounced air cushion is frequently present between the tray and the transport surface. The positive effect of the air cushion being sucked away by the negative pressure device on the rebound behavior is then particularly pronounced.

The trays can have a rectangular or substantially rectangular base surface (e.g.

rectangular with rounded corners). However, the invention is not restricted thereto and the trays can have a differently shaped base surface. For example, trays with a round or oval base surface (for example, cup-shaped trays) are within the scope of the present invention.

According to an advantageous embodiment, the transport unit is part of a packaging system, wherein the trays to be dropped and transported away can be packages or components of packages to be filled and/or closed. Advantageously, the transport belt unit is configured to transport the dropped packages to a tray sealer of the packaging system. On the way there, the packages can be filled with product at a filling station. The packages can either be transported entirely from the transport belt unit up to the tray sealer or else transported only toward the tray sealer, wherein a last portion of the transport to the tray sealer can be taken over by a further transport device.

The invention also comprises a method for transporting trays. This method can be performed with the transport unit according to the invention.

The method according to the invention comprises dropping individual or a group of trays from a stack of trays into a drop area so that the trays are received by a transport surface of a transport belt unit, wherein the transport surface passing through the drop area. The dropped trays are transported away with the transport belt unit. According to the invention, the transport surface of the transport belt unit may comprises at least one opening. A suction force is generated by a negative pressure device and applied in the drop area through one or more openings of the transport surface and the suction force act on the dropped trays in the direction towards the transport surface.

As explained with respect to the device, rebound of the trays is prevented, or the strength of the rebound is reduced, by generating the suction effect with the negative pressure device in the drop area. In addition, the friction between the tray and the transport surface is increased immediately after dropping to result in a more accurate and reliable positioning of the trays on the transport surface.

Further features and advantages of the method according to the invention can be derived from the description of the device.

Other aspects and advantages of the present invention will be apparent from the following detailed description of the preferred embodiments and the accompanying drawing figures.

### DESCRIPTION OF THE SEVERAL VIEWS OF THE DRAWING

In the following, an advantageous embodiment of the present invention will be explained in more detail making reference to the following drawings, in which the individual figures show:

FIG. 1 is a schematic top view of one embodiment of a packaging system with a transport unit according to the teachings of the present invention;

FIG. 2 is a schematic sectional view of the packaging system of FIG. 1 cut along the section line A-A;

FIG. 3 is a schematic partial view of a section through the packaging system of FIG. 1 cut along the section line B-B;

FIG. 4 is a schematic top view of one embodiment of the transport surface of a transport unit according to the teachings of the present invention; and

FIG. 5 is a schematic top view of another embodiment of the transport surface of a transport unit according to the teachings of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

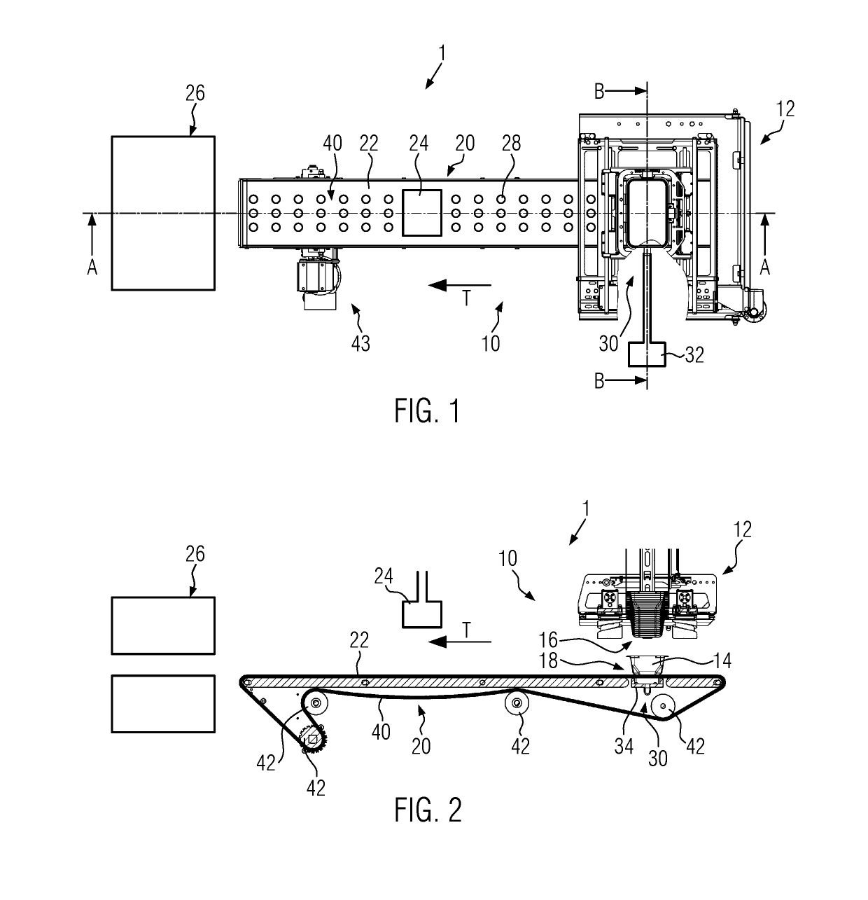

FIG. 1 shows a schematic top view of a packaging system 1 with a transport unit 10 according to one embodiment. FIG. 2 shows packaging system 1 in a section along section line A-A from FIG. 1. Transport unit 10 of packaging system 1 comprises a de-stacking device 12 which is configured to drop trays 14 individually from a stack 16 into a drop area 18. It would also be possible to drop trays 14 in groups. In the embodiment shown, dropping a tray 14 is effected by releasing the lowermost tray 14 of stack 16. However, it would also be conceivable to provide a de-stacking device which actively drops trays 14. Transport unit 10 also comprises a transport belt unit 20 with a transport surface 22 passing through drop area 18. Dropped trays 14 are in the drop area 18 received by transport surface 22 and then transported away on transport surface 22 in a transport direction T. In the packaging system 1 of the embodiment shown, dropped trays 14 are first transported to a filling station 24 where they can be filled, for example, with foodstuffs. Trays 14 are then transported further to a tray sealer 26 which is configured to seal trays 14. Tray sealer 26 can be, for example, a sealing station for sealing plastic trays airtight with a film.

Transport surface 22 in the embodiment shown in FIG. 1 comprises a plurality of openings 28. Transport unit 10 comprises a negative pressure device 30 which is configured to generate a suction effect in drop area 18 through openings 28 of transport surface 22 which sucks dropped trays 14 in drop area 18 in the direction towards transport surface 22. For this purpose, negative pressure device 30 comprises a negative pressure generator 32, for example, a side channel blower and a suction attachment 34 connected thereto and defining a suction opening 36.

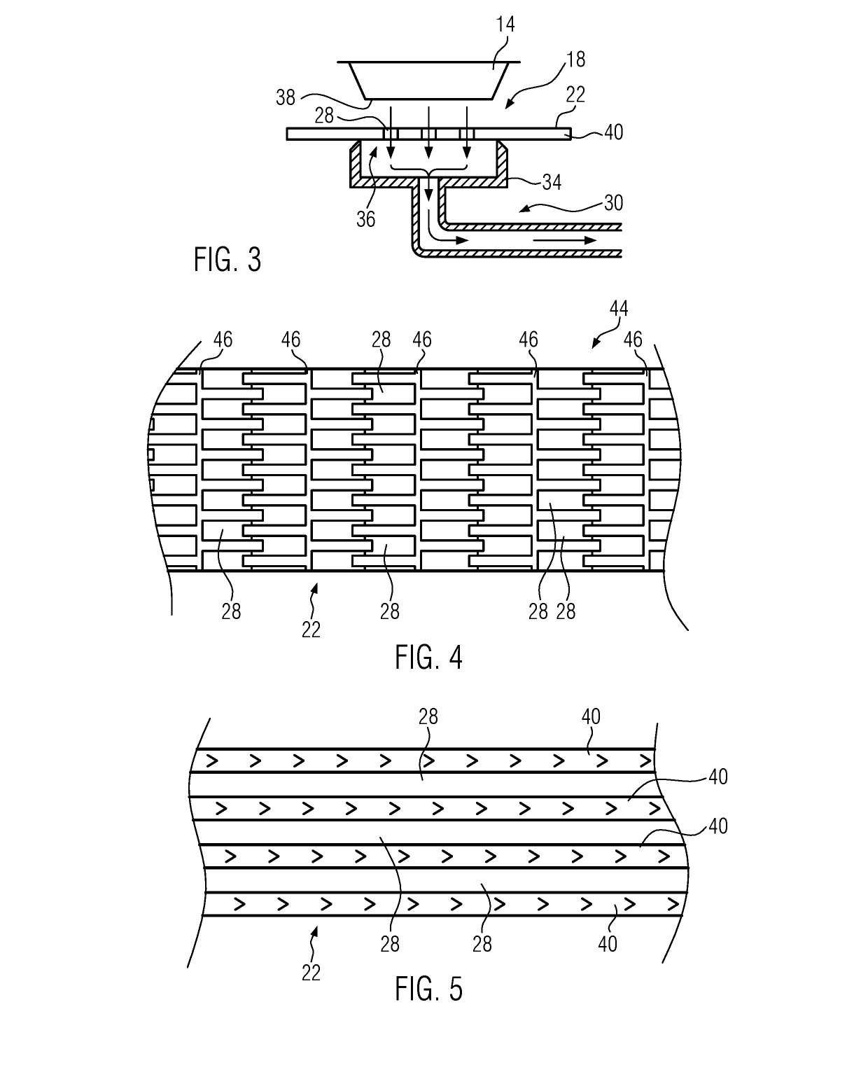

FIG. 3 shows a section of a sectional view through transport unit 10 in drop area 18 along section line B-B shown in FIG. 1. As can be seen there in detail, suction attachment 34 is arranged on the side of transport surface 22 that is opposite to that of dropped trays 14. The arrows in FIG. 3 represent the suction effect which negative pressure device 30 generates through openings 28 of transport surface 22. Dropped trays 14 in drop area 18 are sucked in the direction toward transport surface 22. Negative pressure device 30 sucks away an air cushion being present between tray 14 and transport surface 22 during the dropping of a tray 14. This configuration may result in preventing tray 14 from rebounding after impacting transport surface 22, thereby rendering its position or orientation on transport surface 22 being more predictable. In addition, the suction effect produces a pressure difference between an upper side of tray 14 and a base surface 38 facing transport surface 22. This pressure difference presses tray 14 onto transport surface 22. As a result, the friction of tray 14 on transport surface 22 is increased immediately after dropping, and tray 14 can be transported away more quickly and helping to ensure that transport surface 22 does not pass underneath tray 14 without taking tray 14 along.

The suction force generated by negative pressure device 30 may be confined to drop area 18 and may be concentrated there by suction attachment 34. It can thereby be ensured that the suction force does in fact act in drop area 18 to improves, reduce or prevent the rebound behavior of trays 14 impacting transport surface 22.

In the embodiment shown in FIGS. 1, 2 and 3, transport belt unit 20 comprises a transport belt 40 which forms transport surface 22. For driving and deflecting transport belt 40, transport belt unit 20 further comprises a plurality of drive or deflection rollers 42, a drive unit 43 and a frame structure for transport belt 40. Openings 28 in transport surface 22 are according to this embodiment realized by openings 28 distributed in transport belt 40 along its entire length. As shown in FIG. 1, these openings 28 can have a circular cross-section. However, other suitable cross-sections are also conceivable, such as, for example, a polygonal, an elliptical, a semicircular or an irregularly shaped cross-section. Slots are also conceivable, provided they permit the generation of the suction effect through transport surface 22. The distribution and size of openings 28 can be adapted to trays 14 being transported. Openings 28 can, for example, each have an opening area of less than 1 cm², 2 cm² or 5 cm² or more than 1 cm², 2 cm² or 5 cm².

However, it is also conceivable to form openings 28 in transport surface 22 in a different manner. For example, transport belt unit 20 could instead of transport belt 40 shown in FIGS. 1, 2 and 3, comprise a link belt 44 which forms transport surface 22 as shown schematically in FIG. 4. Link belt 44 comprises a plurality of links 46 which interact to form transport surface 22. Link belts 44 of various configurations are known and are particularly suitable for applications where the belt's flexibility or its characteristics when turning corners are important. As shown in FIG. 4, intermediate spaces between links 46 of link belt 44 form openings 28 of transport surface 22. Negative pressure device 30 can generate a suction effect upon dropped trays 14 through these intermediate spaces.

It is as a further alternative illustrated in FIG. 5, it is also conceivable that transport belt unit 20 may comprise a plurality of spaced transport belts 40 running in parallel and transversely relative to the transport direction T and forming transport surface 22. FIG. 5 shows a schematic top view onto such a transport surface 22. In this embodiment, it is not necessary to provide openings in transport belts 40 themselves. Openings 28 allowing the suction effect to be generated through transport surface 22 are already provided by the intermediate spaces between adjacent transport belts 40. The number of parallel transport belts 40 and the dimensions of the intermediate spaces between them can be adjusted depending on the application and the size of trays 14. It would of course also be conceivable to provide additional openings 28 in individual transport belts 40.

It would also be conceivable to alternatively provide the negative pressure device such that it generates a suction effect in the region of filling station 24 through one or more of the openings 28 of transport surface 22 which sucks trays 14 in the region of filling station 24 in the direction towards transport surface 22. Trays 14 would thereby have a better footing in the region of filling station 24, as a result of which slippage of trays 14 during the filling process can be prevented or reduced. In addition, the suction effect in the region of filling station 24 would have the effect that product portions which have undesirably ended up next to trays 14 on transport surface 22 during the filling process are sucked away through openings 28. The suction effect in the region of filling station 24 would therefore have a cleaning effect for transport surface 22 in addition to improving the footing of trays 14. This can be particularly advantageous when trays 14 are at filling station 24 filled with products comprising, for example, breading or powders. It is also conceivable that a suction effect is generated both in drop area 18 as well as in the region of filling station 24. This can be achieved by a common negative pressure device or by two separate negative pressure devices.

Instead of a sealing station, a lid closure station can also be provided for closing the trays, at which trays 14 are closed with a lid. This can be done manually or by machine. As an alternative or in addition to the above-described configurations of negative pressure device 30, the negative pressure device 30 can also be provided in the region of such a lid closure station so that the negative pressure device generates a suction force or suction effect through one or more openings 28 of transport surface 22 which in the region of the lid closure station sucks trays 14 in the direction towards transport surface 22. Trays 14 thereby experience improved footing which facilitates closure with a lid and prevents trays 14 from slipping when closed with a lid.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A transport unit comprising:
a de-stacking device configured to drop at least one tray from a stack of trays into a drop area; and
a transport belt unit with a transport surface passing through said drop area for receiving and transporting away said at least one tray, wherein said transport surface comprises one or more openings; and
a negative pressure device for generating a suction force in said drop area through one or more of said openings of said transport surface to apply said suction force to at least one tray in said drop area, said suction force applied in a direction towards said transport surface.

2. The transport unit according to claim 1, wherein the de-stacking device drops a group of trays onto said transport surface.

3. The transport unit according to claim 1, wherein said transport surface is at least in part formed by a link belt and a plurality of intermediate spaces between links of said link belt form said one or more openings of said transport surface.

4. The transport unit according to claim 1, wherein said transport surface is at least in part formed by two or more parallel transport belts, wherein each of at least one adjacent pair of said two or more parallel transport belts are separated by a gap, said gap having a width, said width being a distance in a direction perpendicular to a transport direction, and said gap separating each of said at least one adjacent pair of said two or more parallel transport belts comprising said one or more opening of said transport surface.

5. The transport unit according to claim 1, wherein said negative pressure device comprises a negative pressure generator and a suction attachment in fluid communication with said negative pressure generator, said suction attachment having a suction opening, wherein said suction attachment is disposed in said drop area on the side of said transport surface that is opposite to said at least one dropped trays.

6. The transport unit according to claim 5, wherein a cross-section of said suction opening covers at least a base surface of said at least one tray, wherein said base surface of said at least one tray engages said transport surface after said at least one tray is dropped.

7. The transport unit according to claim 1, wherein said trays are plastic trays, cardboard trays, aluminum trays, glass trays or trays of foamed material.

8. The transport unit according to claim 1, wherein said suction force applied by said negative pressure device is confined to said drop area.

9. A packaging system comprising a transport unit according to claim 1, wherein said trays are packages to be closed.

10. A packaging system according to claim 9, further comprising a tray sealer for closing said packages, wherein said transport belt unit is configured to transport said dropped packages to said tray sealer.

11. A method for transporting trays comprising:
dropping one or more trays from a stack of trays into a drop area either individually or in groups, so that said trays are received by a transport surface of a transport belt unit passing through said drop area;
generating a suction force using a negative pressure device;
applying a suction force upon said one or more trays through one or more opening in said transport surface, said suction force applied in a direction towards said transport surface, said suction force applied at least concurrently with said dropping step; and
transporting away said one or more trays with said transport belt unit after said dropping step.

12. The method according to claim 11, wherein said one or more opening in said transport surface is at least in part formed by a link belt and one or more intermediate spaces between two or more links of said link belt comprise said one or more opening of said transport surface.

13. The method of according to claim 11, wherein said one or more opening in said transport surface is at least in part formed by two or more parallel transport belts which are spaced apart from one another by a gap, and said gap comprising said one or more opening of said transport surface.

14. The method according to claim 11, wherein said trays are plastic trays, cardboard trays, aluminum trays, glass trays or trays of foamed material.

15. The method according to claim 11, wherein said suction force generated by said negative pressure device is confined to said drop area.
